(19) United States
(12) Patent Application Publication
(10) Pub. No.: US 2003/0035414 A1
(43) Pub. Date: Feb. 20, 2003

(54) System and method for mixed mode public and private gatekeeper system

(75) Inventor: William J. Beyda, Cupertino, CA (US)

Correspondence Address: Siemens Corporation, Attn: Elsa Keller, Legal Administrator, Intellectual Property Department, 186 Wood Avenue South, Iselin, NJ, 08830, US

(73) Assignee: Siemens Information

(21) Appl. No.: 09/933,615

(22) Filed: Aug. 20, 2001

(51) Int. Cl. H04L 12/66; H04L 12/56

(52) U.S. Cl. 370/352; 370/401

(57) ABSTRACT

A service provider providing gatekeeper backup services to a plurality of off-site voice packet networks from a single central backup gatekeeper. The gatekeeper maintains a database of local gatekeepers for which the backup service is to be provided. The services provided may be identical to those provided by the corresponding local gatekeeper, or may be a more basic level of service to reduce the cost of the backup service.

### BACKGROUND OF THE INVENTION

1. Field of the Invention

The present invention relates to telecommunications systems and, particularly, to an improved, Internet Protocol telephony system.

### DESCRIPTION OF THE RELATED ART

The International Telecommunications Union (ITU) Recommendation H.323 describes a set of devices and protocols for multimedia communication over packet-switched networks. The four main components defined by the specification are clients (also referred to as terminals or endpoints), multipoint control units, gateways, and gatekeepers.

The H.323 Recommendation provides for separate call signaling, call control and media channels. Typically, call signaling and call control are routed through the gatekeeper, while the media channels (i.e., audio, data and/or video) are routed directly between the endpoints. For example, to place a call between two clients, the calling party client sends a message to a gatekeeper, which resolves the address of the receiving party and sends the appropriate signaling messages to the caller and receiver. Once the signaling and control channels have been established, the endpoints establish the media channel(s). There may be more than one media channel for a call, such as two unidrectional channels for an audio call. The H.225.0 signaling channel and the H.245 call control channel are also used to terminate the call.

If the gatekeeper fails for any reason, existing calls are typically terminated, and new calls via the gatekeeper become impossible. While some call capability may exist using gatekeeper-less operation, many call features will be lost. One solution is to provide a backup gatekeeper on premises that will track other gatekeeper's operations, but providing such a backup can be expensive and may not necessarily provide the desired level of reliability.

### SUMMARY OF THE INVENTION

These disadvantages in the prior art are overcome in large part by a system and method according to the present invention. According to one embodiment of the invention, a gatekeeper is configured to act as a backup to multiple other gatekeepers. The backup gatekeeper maintains a database of users for which it provides the backup services. When one of the subscriber gatekeepers fails or is unavailable, gatekeeper traffic is automatically redirected to the backup. The backup may also maintain in its database a record of what services are provided to each of the subscriber gatekeepers.

A telecommunication system according to one embodiment of the invention includes a plurality of Internet Protocol voice networks, such as telephony over LAN (ToL) networks, including primary gatekeepers. A Service Provider maintains a backup gatekeeper for each of the ToL networks. The backup gatekeeper maintains a database associated with all the ToL networks it provides backup service to. A proxy server at each of the networks receives all gatekeeper requests and first tries to forward the request to the primary gatekeeper. If the appropriate gatekeeper fails to respond, the proxy server forwards the request to the backup gatekeeper, which handles the call.

A telecommunication system according to another embodiment of the invention includes a plurality of Internet Protocol voice networks including primary gatekeepers. System routers, such as load sharing routers, are adapted to route traffic to the primary gatekeepers if they are operational, and to the backup gatekeeper if the appropriate primary gatekeeper is not. The backup gatekeeper then accesses its database for the features it is to provide the user associated with the non-available primary gatekeeper.

A method according to an embodiment of the present invention includes a service provider providing gatekeeper backup services to a plurality of off-site voice packet networks from a single central backup gatekeeper. The gatekeeper maintains a database of local gatekeepers for which the backup service is to be provided. The services provided may be identical to those provided by the corresponding local gatekeeper, or may be a more basic level of service to reduce the cost of the backup service.

### BRIEF DESCRIPTION OF THE DRAWINGS

A better understanding of the invention is obtained when the following detailed description is considered in conjunction with the following drawings in which:

FIG. 1 is a diagram illustrating an H.323 system according to an embodiment of the invention;

FIG. 2 is a block diagram of a backup gatekeeper in accordance with an embodiment of the present invention;

FIG. 3 is a flowchart illustrating operation of an embodiment of the present invention;

FIG. 4 is a flowchart illustrating operation of an embodiment of the present invention; and

FIG. 5 is a flowchart illustrating operation of an embodiment of the present invention.

### DETAILED DESCRIPTION OF THE INVENTION

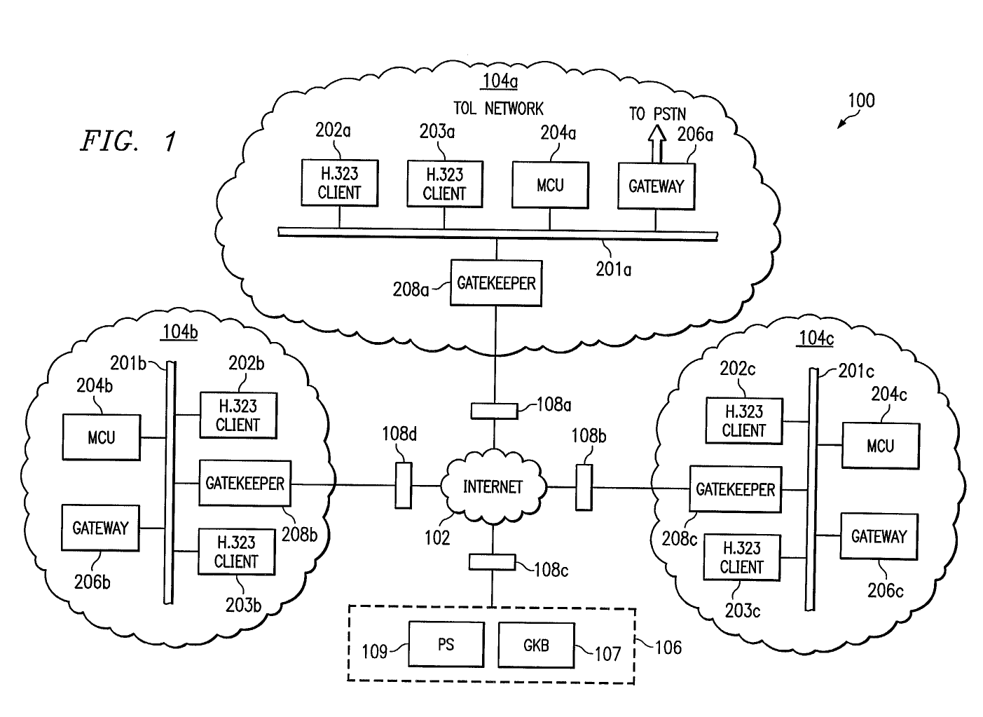

Turning now to the drawings, and with particular attention to FIG. 1, a diagram illustrating an exemplary telecommunications system 100 according to an embodiment of the present invention is shown. It is noted that, while described herein with regard to an H.323 network, the invention is equally applicable to any voice packet network such as MGCP (Media Gateway Control Protocol), SIP+ (Inter MGS Protocol), SGCP, MEGACO, and generally, any voice or multimedia over IP scheme. Further, it is noted that, while described specifically in the context of voice packets, the present invention encompasses the use of any multimedia information, such as video, data, voice, or any combinations thereof. Finally, it is noted that an exemplary generic H.323 system is the HiPath series available from Siemens Corp.

As shown, the telecommunications network 100 includes a plurality of ToL (telephony over LAN) networks 104a, 104b, 104c coupled via the Internet 102. A Network Services Provider, such as an Internet Service Provider or Application Service Provider) 106 including a backup gatekeeper 107 according to an embodiment of the present invention couples to the ToL networks 104a-104c via the Internet 102, as well. In certain embodiments, the NSP 106 may include a proxy server 109, as well. In addition, as shown, routers 108a-108d may be used to route packets to the appropriate destinations. In practice, more or fewer than three ToL networks may be coupled in the network. Additional devices and networks, such as non-voice or multimedia devices, may also be coupled in the network. The network can include packet-switched Internet Protocol (IP) and Internet Packet Exchange (IPX) over Ethernet, Fast Ethernet and Token Ring networks. Thus, the figure is exemplary only.

Each ToL network 104a-104c includes a local area network (LAN) or packet network 201a-201c. Coupled to the LANs 201a-201c may be a variety of H.323 terminals 202a-202c, 203a-203c, multi-point control units (MCU) 204a-204c, H.323 gateways 206a-206c, primary H.323 gatekeepers 208a-208c and a plurality of other devices such as personal computers (not shown). It is noted that each ToL network 104a-104c may include more or fewer of the various components illustrated.

In the example illustrated, the H.323 terminals 202a-202c, 203a-203c are in compliance with the H.323 Recommendation. Thus, the H.323 terminals 202a-202c, 203a-203c support H.245 control signaling for negotiation of media channel usage, Q.931 (H.225.0) for call signaling and call setup, H.225.0 Registration, Admission and Status (RAS), and RTP/RTCP for sequencing audio and video packets. The H.323 terminals 202a-202c, 203a-203c may further implement audio and video codecs, T.120 data conferencing protocols and MCU capabilities.

The gateways 206a-206c couple the ToL networks 104a-104c to external networks, such as the public switched telephone network (PSTN). The MCUs 204a-204c support multi-point operation in accordance with the H.323 Recommendation. The gatekeepers 208a-208c handle call signaling, call requests, address translation, etc. Further details concerning the H.323 Recommendation may be obtained from the International Telecommunications Union; the H.323 Recommendation is hereby incorporated by reference in its entirety as if fully set forth herein.

In operation, the users of the ToL networks 104a-104c subscribe to the ISP 106 to provide backup services. When one of the local gatekeepers 208a-208c is unavailable, the call requests and other signaling is passed through the backup gatekeeper. The gatekeeper 107 thus stores a database of local gatekeeper profiles. It is noted, however, that the backup gatekeeper need not necessarily provide the same range of services as the local gatekeepers.

The determination of whether backup services are needed may be accomplished in a variety of ways. For example, in one embodiment of the invention, the routers 108 implement load sharing and can identify if a local client gatekeeper is on line. If the local gatekeeper is offline, the routers can route the packets to the backup. In another embodiment, a proxy server is used to direct all signaling. The proxy server receives call requests, for example, and routes them to the local client gatekeeper if that gatekeeper is functioning. Otherwise, it routes the call signaling to the backup. Such a proxy server may be implemented as any system suitable to identify packet destinations and whether a destination is functioning such as a load sharing device, such as those available from Cisco Systems, Inc.

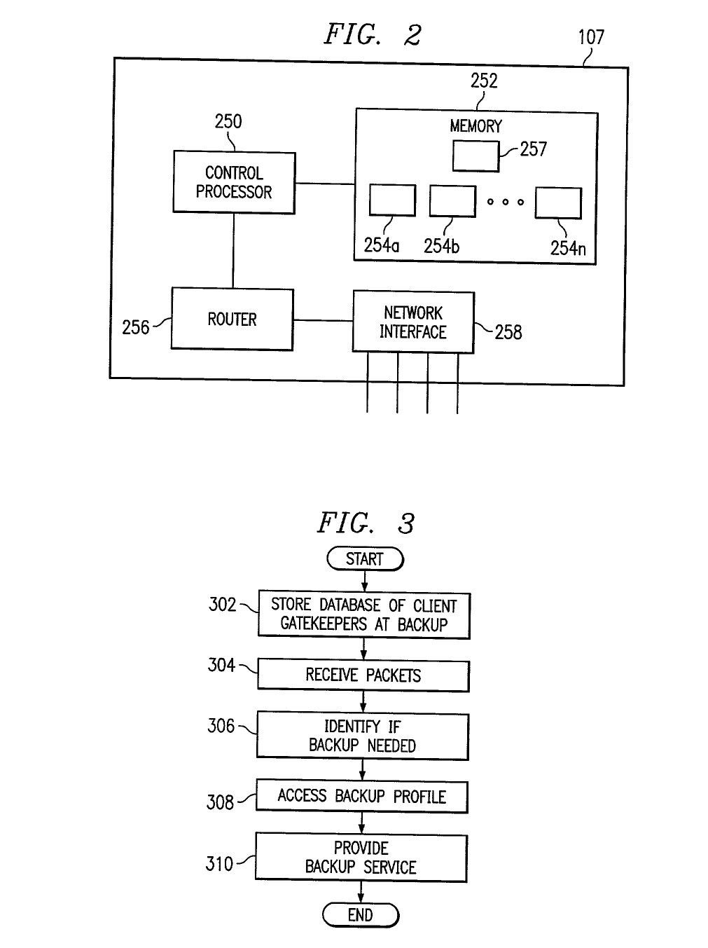

FIG. 2 depicts a backup gatekeeper in accordance with an embodiment of the present invention. The backup gatekeeper 107 include a control processor 250, a memory 252, a router 256, and a network interface 258. The control processor may be implemented, for example, as a Pentium series processor running a Windows NT operating system. The memory 252 maintains a database of gatekeeper users or user profiles 254a-254n for which backup services are provided. For example, the users may be arranged by IP address. In addition, the memory may store an “EnterpriseSelect” software module 257 executable by the control processor 250. Packets are inspected for their IP address or destination and used to determine which party needs backup services. Then, the packets are routed to the backup gatekeeper 107. The control processor 250 checks the memory database of the user gatekeepers to determine which services are enabled for that user (e.g., call forwarding, etc.), and whether there are any customer specific items that apply (e.g., closed user groups, dialing plans, etc.). Then the gatekeeper feature associated with the user can be activated and configured appropriately including, for example, billing services. Either multiple instances of gatekeeper software may be implemented (i.e., one per user, preconfigured) or a single gatekeeper program configured with all possible features can select which features are to be afforded a user. The backup gatekeeper 107 then functions as the signaling and routing gatekeeper for the call. It is noted that, while illustrated as a single discrete unit, the backup gatekeeper functionality could also be implemented, for example, as a plurality of individual gatekeepers controlled by a control module. Thus, the figure is exemplary only.

FIG. 3 illustrates a method for gatekeeper operation according to an embodiment of the present invention. In a step 302, the gatekeeper user profiles are stored in the backup gatekeeper. For example, local client gatekeepers may be identified by their own IP addresses, or by the IP addresses of clients they serve. In a step 304, the backup gatekeeper receives data packets. In one embodiment, the packets are received from a proxy server which has identified whether a particular client gatekeeper is functioning. In another embodiment, the packets are received from a router which has done the same identification. The router or proxy server may make this determination, for example, by sending one or more control signals to the local gatekeeper and waiting a predetermined period before no reply is received. In 306, the backup gatekeeper identifies that backup functions are needed. In step 308, the backup gatekeeper accesses the backup gatekeeper profile for the system identified by the sender or receiver IP address in the packets. In step 310, the backup gatekeeper provides the appropriate backup services to the client.

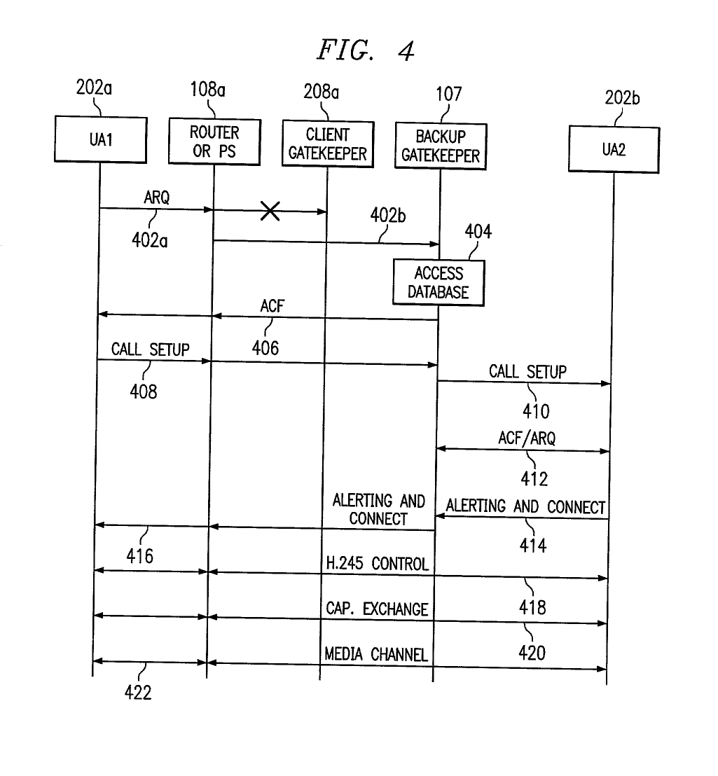

FIG. 4 illustrates signal flow for system operation according to one embodiment of the invention. Shown schematically are, for example, a caller (UA1) 202a, called party (UA2) 202b, a router 108a, a client (local) gatekeeper 208a and a backup gatekeeper (GKB) 107. The reference numerals refer to components identified in FIG. 1; it is noted, however, that other components may be operable in a similar manner. If the endpoint UA1 wants to establish a call to another user UA2, the endpoint UA1 sends an ARQ message (AdmissionRequest) 402a, which is to be routed by the router or proxy server to the gatekeeper GK. Either the router or the proxy server determines, however, that the client gatekeeper GK is not in service. The backup gatekeeper GKB receives the ARQ message from the router, identifies the user local gatekeeper, and, in 404, accesses the gatekeeper profile database to identify the services to be provided for the non-functioning gatekeeper GK. The backup gatekeeper GKB responds to the ARQ with an ACF (Admission Confirm) message 406 to the client UA1. Next, in response to the ACF message, the client UA1 sends an H.225.0 set-up message 408 to the backup gatekeeper GKB. The Call Setup message includes the identity of the called party. It is noted that in alternate embodiments, the gatekeeper GKB does not access the database until the call setup message is received.

In 410, the backup gatekeeper GKB will forward the call setup message to the destination UA2. In response, the endpoint UA2 conducts an ARQ/ACF exchange 412 with the backup gatekeeper GKB. The endpoint UA2 then sends H.225.0 Alerting and Connect messages 414 to the backup gatekeeper GKB as the call progresses to the connect state. The backup gatekeeper GKB, in turn provides the Alerting and Connect messages 416 to the endpoint UA1. The Alerting or Connect message include the Gatekeeper H.245 Control Channel Transport Address, which is used to establish the H.245 control channel 418. Next, an H. 245 capability exchange 420 is undertaken. Finally, the media channel 422 is opened between endpoint UA1 and UA22.

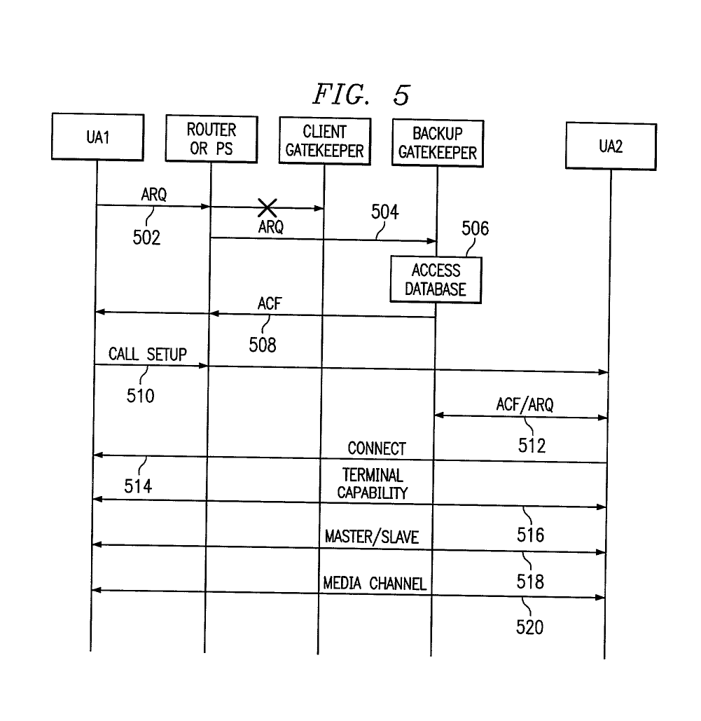

FIG. 5 illustrates signaling for another implementation of the invention and, in particular, an embodiment using a direct call model. As in FIG. 4, shown schematically are a caller (UA1) 202a, called party (UA2) 202b, a router 108a, a client (local) gatekeeper (GK) 208a and a backup gatekeeper (GKB) 107. In 502, the UA1 sends an ARQ message requesting that a call to endpoint UA2 be allowed using a direct call model. The ARQ message is to be routed by the router or proxy server to the gatekeeper GK. Either the router or the proxy server determines, however, that the client gatekeeper GK is not in service. The backup gatekeeper GKB receives the ARQ message from the router in 504, and, in 506, accesses the gatekeeper profile database to identify the services to be provided for the non-functioning gatekeeper GK. In 508, the backup gatekeeper GKB responds with an ACF message to the endpoint UA1. The ACF message includes a Call Signaling Transport Channel Address of the endpoint UA2. In response to the ACF message, the endpoint UA1 sends an H.225.0 Setup message 510 directly to endpoint UA2. In response to the setup message, the endpoint UA2 conducts an ARQ/ACF exchange 512 with the gatekeeper GKB (a router on its end, not shown, having identified that the backup is to be used). Next, the endpoint UA2 sends an H.225.0 Connect message 510 to the endpoint UA1 to progress the call to a connect state. The endpoint UA1 and UA2 then exchange H.245 terminal capability messages 516. The endpoints next exchange H.245 master-slave determination messages 518 and any other needed H.245 messages, and establish the media channel 520.

The invention described in the above detailed description is not intended to be limited to the specific form set forth herein, but is intended to cover such alternatives, modifications and equivalents as can reasonably be included within the spirit and scope of the appended claims.

What is claimed is:

1. A Voice over IP (VoIP) telecommunications system, comprising:
a plurality of local VoIP networks serviced by local gatekeepers; and
a backup gatekeeper, said backup gatekeeper adapted to provide gatekeeper services to individual ones of said local VoIP networks if a local gatekeeper servicing said local VoIP network is not available.

2. A Voice over IP (VoIP) telecommunications system in accordance with claim 1, wherein said backup gatekeeper is adapted to maintain local gatekeeper profiles in a database and access said local profiles when a corresponding local gatekeeper is unavailable.

3. A Voice over IP (VoIP) telecommunications system in accordance with claim 2, further comprising a proxy server adapted to direct call signaling to said local gatekeepers if said local gatekeepers are available and to said backup gatekeeper if said local gatekeepers are not.

4. A Voice over IP (VoIP) telecommunications system in accordance with claim 2, further comprising one or more routers, said one or more routers adapted to direct call signaling to said local gatekeepers if said local gatekeepers are available and to said backup gatekeeper if said local gatekeepers are not.

5. A Voice over IP (VoIP) telecommunications system in accordance with claim 2, wherein said backup gatekeeper is provided by a Network Services Provider.

6. A telecommunications gatekeeper, comprising:
a control unit; and
a plurality of local gatekeeper modules corresponding to local gatekeepers associated with said telecommunications gatekeeper, wherein said control unit is adapted to select for operation individual ones of said local gatekeeper modules when corresponding ones of said local gatekeepers are unavailable.

7. A telecommunications system, comprising:
a plurality of voice over packet networks, each of said voice over packet networks having an associated local gatekeeper; and
a backup gatekeeper having a plurality of local gatekeeper modules corresponding to local gatekeepers and adapted to select for operation individual ones of said local gatekeeper modules when corresponding ones of said local gatekeepers are unavailable.

8. A telecommunications system in accordance with claim 7, further comprising a proxy server adapted to route gatekeeper signaling to and from said backup gatekeeper if a local gatekeeper is not available.

9. A telecommunications system in accordance with claim 7, further comprising a router adapted to route gatekeeper signaling to and from said backup gatekeeper if a local gatekeeper is not available.

10. A telecommunications system in accordance with claim 7, wherein said backup gatekeeper is programmed to provide said local gatekeeper modules for service as a subscription service, said backup gatekeeper provided at a location of a service provider.

11. A method, comprising:
monitoring whether a plurality of local gatekeepers are available; and
providing backup gatekeeper services from a backup gatekeeper if any of said local gatekeepers are determined to not be available.

12. A method in accordance with claim 11, said monitoring comprising a router determining if a local gatekeeper is unavailable and routing gatekeeper signaling to said backup gatekeeper in response thereto.

13. A method in accordance with claim 11, said monitoring comprising a proxy server determining if a local gatekeeper is unavailable and routing gatekeeper signaling to said backup gatekeeper in response thereto.

14. A method, comprising:
providing a plurality of local VoIP networks serviced by local gatekeepers; and
providing a backup gatekeeper, said backup gatekeeper adapted to provide gatekeeper services to individual ones of said local VoIP networks if a local gatekeeper servicing said local VoIP network is not available.

15. A method in accordance with claim 14, wherein said backup gatekeeper is adapted to maintain local gatekeeper profiles in a database and access said local profiles when a corresponding local gatekeeper is unavailable.

16. A method in accordance with claim 15, further comprising a proxy server adapted to direct call signaling to said local gatekeepers if said local gatekeepers are available and to said backup gatekeeper if said local gatekeepers are not.

17. A method in accordance with claim 15, further comprising one or more routers, said one or more routers adapted to direct call signaling to said local gatekeepers if said local gatekeepers are available and to said backup gatekeeper if said local gatekeepers are not.

18. A method in accordance with claim 15, wherein said backup gatekeeper is provided by an Internet Service Provider.
